(19) United States
(12) Patent Application Publication
(10) Pub. No.: US 2020/0366021 A1
(43) Pub. Date: Nov. 19, 2020

(54) Plug-in Coupling for a Battery Unit

(71) Applicant: Hilti Aktiengesellschaft, Schaan (LI)

(72) Inventors: Ralf MEIXNER, Germaringen (DE); Markus HOLUBARSCH, Landsberg am Lech (DE)

(21) Appl. No.: 16/639,032

(22) PCT Filed: Aug. 8, 2018
(86) PCT No.: PCT/EP2018/071455

§ 371 Date: Feb. 13, 2020

(30) Foreign Application Priority Data
Aug. 18, 2017 (EP) 17186786.4

(51) Int. Cl. H01R 13/18; H01R 13/11

(52) U.S. Cl. CPC H01R 13/18; H01R 13/113

(57) ABSTRACT

A plug-in coupling for making electrical contact between an electric motor included in a hand-held power tool and a battery unit, which is to be accommodated by the hand-held power tool, wherein the plug-in coupling has at least one electrical contact plate to be connected to the hand-held power tool and a corresponding contact plug with two opposing resilient contact limbs, wherein the contact plug is to be arranged on the battery unit and is to be slid onto the contact plate in the sliding-on direction and withdrawn from same in the withdrawal direction, and wherein each of the resilient contact limbs has a contact region which electrically contacts a respective side of the contact plate in the contacted state, wherein the contact regions are spaced apart from one another, in the uncontacted state, relative to a deflection direction of the resilient contact limbs.

The present invention relates to a plug-in coupling for making electrical contact between an electric motor included in a hand-held power tool and a battery unit. The battery unit is to be accommodated by a hand-held power tool. The plug-in coupling has at least one electrical contact plate to be connected to the hand-held power tool and a corresponding contact plug with two opposing resilient contact limbs. The contact plug is to be arranged on the battery unit and is to be slid onto the contact plate in the sliding-on direction and withdrawn from same in the withdrawal direction. Each of the resilient contact limbs has a contact region which electrically contacts a respective side of the contact plate in the contacted state.

### BACKGROUND

Plug-in couplings of the type mentioned at the beginning are known in principle from the prior art.

### SUMMARY OF THE INVENTION

It is an object of the present invention to provide a plug-in coupling which promotes stable power transfer under application-related loads, e.g. vibration.

The present invention provides that the contact regions are spaced apart from one another, in the uncontacted state, relative to a deflection direction of the resilient contact limbs.

By means of this contact configuration, the resulting plug-in forces during the insertion of a battery unit can be kept low and, in the connected state, it is nevertheless possible to achieve sufficiently high contact forces which allow the desired stable power transfer under application-related loads.

The invention incorporates the insight that the current carrying capacity of a plug-in coupling in operation under real conditions can be enhanced by the technical embodiment of the contact pairing. Particularly influential here is the resultant normal contact force in the plugged (contacted) state and the material thickness of the contact plate. However, a high normal force and a high material thickness of the contact plate lead to a high plug-in force when the battery unit is inserted into the hand-held power tool, and this has been recognized as disadvantageous.

In contrast to plug-in couplings known from the prior art, e.g. the plug-in coupling known from DE 100 66 273 B4 for example, the contact regions are spaced apart from one another in the uncontacted state, and a high current carrying capacity of the plug-in coupling combined, at the same time, with low plug-in forces is thereby achieved.

In a particularly preferred embodiment, it is envisaged that a spacing of the contact regions relative to one another in the uncontacted state, said spacing being defined parallel to the deflection direction of the resilient contact limbs, amounts to 10 to 40 percent of the thickness of the contact plate. In this region, a sufficiently high contact force is achieved, allowing stable power transfer, in combination, at the same time, with low resultant plug-in forces.

It has proven advantageous if the defined spacing of the contact regions relative to one another in the uncontacted state amounts to 0.3 millimeters. In the uncontacted state, the defined spacing can amount to between 0.2 millimeters and 0.4 millimeters. The contact plate preferably has a thickness of between 0.75 millimeters and 3 millimeters. The thickness of the contact plate is defined parallel to the deflection direction of the resilient contact limbs.

It has proven advantageous if the contact limbs have a joining angle which is larger than a holding angle of the contact limbs. As an alternative, the joining angle and holding angle of the contact limbs can be equal.

In another preferred embodiment, each of the contact limbs has an elastic double tongue. Each of the double tongues can be supported via two additional spring elements which counteract spreading apart of the two elastic double tongues which are located opposite one another.

With a view to improved power transmission, it has proven advantageous if the contact regions are of linear design. As an alternative or in addition, the contact regions can extend both perpendicularly to the sliding-on direction and perpendicularly to the deflection direction.

The plug-in coupling preferably has two contact plates spaced apart from one another and/or two contact plugs spaced apart from one another.

It has proven advantageous if the contact plug is made available as a stamping.

The invention also provides a hand-held power tool having a plug-in coupling as described above, wherein the electrical contact plate of the plug-in coupling is connected to the hand-held power tool, and the contact plug is arranged on a battery unit assigned to the hand-held power tool.

Further advantages can be found in the description of the figures that follows. The figures depict various exemplary embodiments of the present invention. The figures, the description and the claims contain numerous features in combination. A person skilled in the art will expediently also consider the features individually and combine them to produce further useful combinations.

### BRIEF DESCRIPTION OF THE DRAWINGS

In the figures, identical and similar components are denoted by the same reference signs. In the figures:

FIG. 1 shows a preferred exemplary embodiment of a plug-in coupling according to the invention in a contacted state;

FIG. 2 shows the plug-in coupling from FIG. 1 in the uncontacted state;

FIG. 3 shows a detailed illustration of the contact plug from FIG. 1; and

FIGS. 4a, 4b,4c, and 4d show various views of another exemplary embodiment of a contact plug.

### DETAILED DESCRIPTION

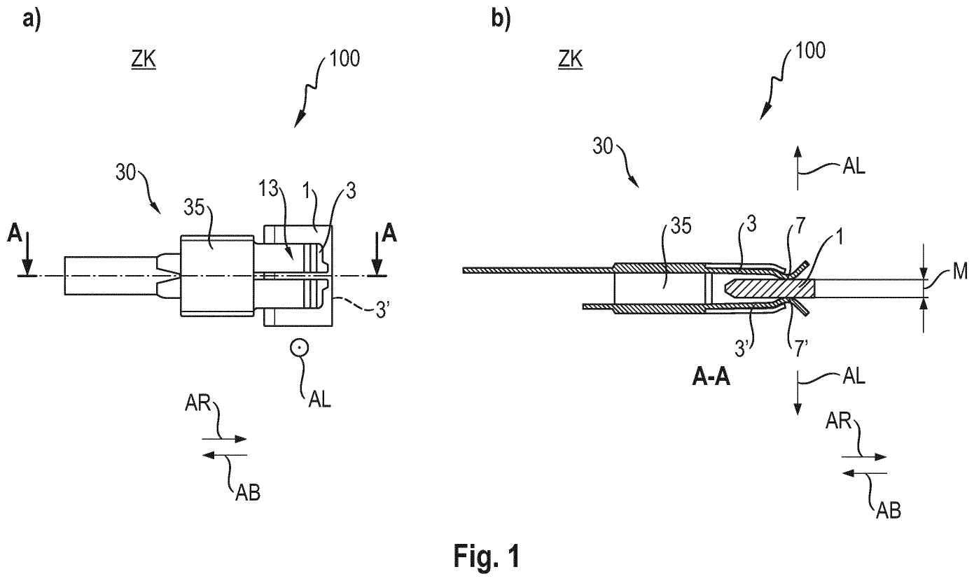

With reference to FIG. 1, a plug-in coupling 100 is first of all described in the contacted state ZK. In this respect, FIG. 1 shows a plan view of the plug-in coupling 100, i.e. a deflection direction AL of the resilient contact limbs 3, 3′ projects from the plane of the image.

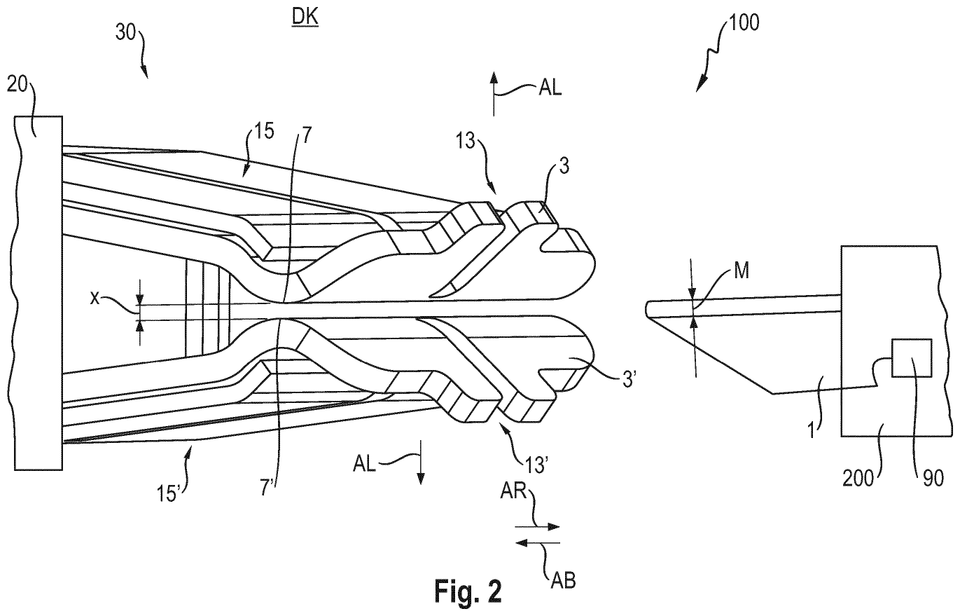

The plug-in coupling 100 has an electrical contact plate 1, which is assigned to an electric hand-held power tool 200 (cf. FIG. 2). The contact plate 1 is of flat design (cf. FIG. 1a) and has a thickness M (cf. FIG. 1b), which is defined parallel to the deflection direction AL of the resilient contact limbs 3, 3′.

As can be seen from FIG. 1a, the resilient contact limb 3 is made available in the form of a double tongue 13. This double tongue 13 is pressed into a plug housing 35 of the contact plug 30.

In FIG. 1b, on the right, which shows a section A-A along section line A-A shown in FIG. 1a, the contact regions 7, 7′ of the respective contact limb 3, 3′ are clearly visible. In the contacted state ZK shown in FIG. 1, the contact plug 30 is in electrical contact with the contact plate 1 via the contact regions 7, 7′. In the contacted state ZK shown, the contact regions 7, 7′ make electrical contact with a respective side of the contact plate 1.

The contact regions 7, 7′, which are spaced apart in the uncontacted state DK according to the invention, are readily visible in FIG. 2.

FIG. 2 shows a preferred exemplary embodiment of a plug-in coupling 100 for making electrical contact between an electric motor 90 included in a hand-held power tool 200 and a battery unit 20 which is to be accommodated by the hand-held power tool 200.

The plug-in coupling 100 has at least one electrical contact plate 1 connected to the hand-held power tool 200 and a corresponding contact plug 30. The contact plug 30 has two opposing resilient contact limbs 3, 3′. In the exemplary embodiment illustrated in the present case, the contact plug 30 is arranged on the battery unit 20.

In the sliding-on direction AR, the contact plug 30 can be slid onto the contact plate 1 and withdrawn in corresponding fashion from the contact plate 1 in the withdrawal direction AB.

In the uncontacted state DK, which is shown in FIG. 2, the contact regions 7, 7′ are spaced apart from one another, relative to a deflection direction AL of the resilient contact limbs 3, 3′. In other words, there is a defined (minimum) spacing X of the contact regions 7, 7′ in the uncontacted state DK. By way of example, the spacing X amounts to 0.3 millimeters.

As can be seen from FIG. 2, the contact regions 7, 7′ are the mutually closest points or regions of the contact limbs 3, 3′, when viewed parallel to the deflection AL.

In the preferred exemplary embodiment in FIG. 2 (not to scale), the spacing X of the contact regions 7, 7′ amounts to 10 percent of the thickness M of the contact plate 1. By way of example, the thickness M of the contact plate 1 accordingly amounts to 3 millimeters.

As can likewise be seen from FIG. 2, the contact regions 7, 7′ are of linear design and extend both perpendicularly to the sliding-on direction AR and perpendicularly to the deflection direction AL.

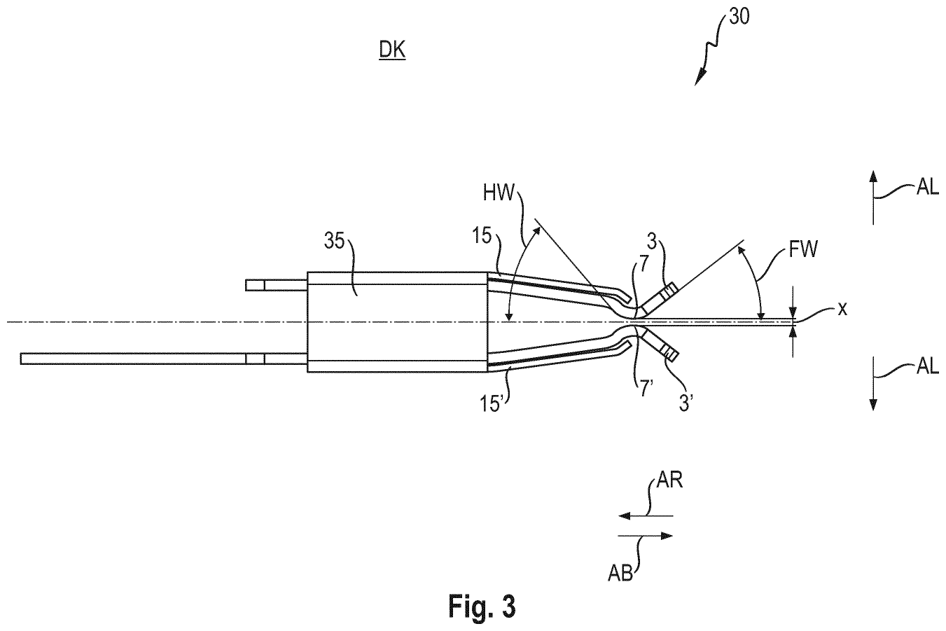

As can furthermore be seen from FIG. 2, each of the contact limbs 3, 3′ is formed by a double tongue 13, 13′. Each of the double tongues 13, 13′ is supported via two additional spring elements 15, 15′ (part of the plug housing 35, cf. FIG. 3). These additional spring elements 15, 15′ counteract spreading apart of the two elastic double tongues 13, 13′ which are located opposite one another.

As is readily apparent from a combined examination of FIGS. 1 and 2, the contact regions 7, 7′ are spaced apart from one another both in the contacted state ZK (cf. FIG. 1) and in the uncontacted state DK (cf. FIG. 2). In the contacted state ZK, the spacing of the contact regions 7, 7′ is equal to the thickness M of the contact plate 1. In the uncontacted state DK, a spacing X of the contact regions 7, 7′ amounts to between 10 to 40 percent of the thickness M of the contact plate 1 and, in the preferred exemplary embodiment, about 10 percent.

FIG. 3 shows the contact plug 30 in side view. It is clearly evident that the contact limbs 3, 3′ have a joining angle FW, which, by way of example, is equal to a holding angle HW of the contact limbs 3, 3′. In the exemplary embodiment under consideration, the joining angle FW is approximately 39 degrees. It can likewise be seen from FIG. 3 that the spacing X of the contact regions 7, 7′ amounts to 0.3 millimeters.

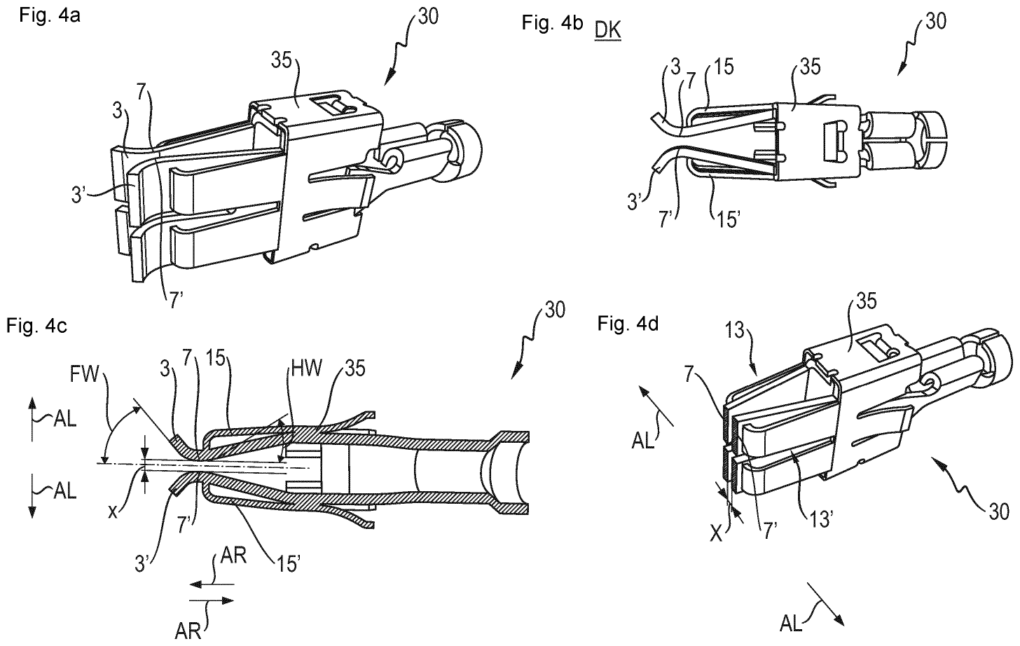

Finally, FIGS. 4a, 4b, 4c and 4d show another preferred exemplary embodiment of a contact plug 30 in various views. The contact plug 30 in FIGS. 4a to 4d is made available as a stamping, wherein the contact limbs 3, 3′ are pressed into a plug housing 35 of the contact plug 30. The additional spring elements 15, 15′ already described are formed in one piece with the plug housing 35.

As can be seen from FIG. 4c, a joining angle FW, i.e. the angle which is effective during mounting in the sliding-on direction AR, is larger than a holding angle HW of the contact limbs 3, 3′ in this exemplary embodiment. The holding angle HW is effective when the contact plug 30 is to be withdrawn in the withdrawal direction AB from a contact plate (not shown here).

It can furthermore be seen in FIG. 4c that, according to the invention, the contact regions 7, 7′ are spaced apart from one another with a defined spacing X, relative to the deflection direction AL of the resilient contact plates 3, 3′, in the uncontacted state DK.

FIG. 4d shows a cross section through the contact regions 7, 7′, i.e. a section through the contact limbs 3, 3′ in the region of the closest proximity thereof. Here too, it can clearly be seen that there is a defined spacing X between the contact regions 7, 7′ of linear design in the uncontacted state DK.

### LIST OF REFERENCE SIGNS

1 Contact plate
3, 3′ Contact limb
7, 7′ Contact region
13, 13′ Double tongue
15, 15′ Additional spring elements
20 Battery unit
30 Contact plug
35 Plug housing
90 Electric motor
100 Plug-in coupling
200 Hand-held power tool
AL Deflection direction
AR Sliding-on direction
AB Withdrawal direction
DK Uncontacted state
FW Joining angle
HW Holding angle
M Thickness of the contact plate
ZK Contacted state
X Spacing between the contact regions

What is claimed is:

1-11. (canceled)

12: A plug-in coupling for making electrical contact between an electric motor included in a hand-held power tool and a battery unit to be accommodated by the hand-held power tool, the plug-in coupling comprising:
at least one electrical contact plate to be connected to the hand-held power tool; and
a corresponding contact plug with two opposing resilient contact limbs, wherein the contact plug is to be arranged on the battery unit and is to be slid onto the contact plate in a sliding-on direction and withdrawn from the contact plate in a withdrawal direction, each of the resilient contact limbs having a contact region electrically contacting a respective side of the contact plate in a contacted state,
the contact regions being spaced apart from one another, in an uncontacted state, relative to a deflection direction of the resilient contact limbs.

13: The plug-in coupling as recited in claim 12 wherein a spacing of the contact regions relative to one another in the uncontacted state defined parallel to the deflection direction amounts to 10 to 40 percent of a thickness of the contact plate.

14: The plug-in coupling as recited in claim 13 wherein the spacing amounts to between 0.2 millimeters and 0.4 millimeters.

15: The plug-in coupling as recited in claim 14 wherein the spacing amounts to between 0.3 millimeters.

16: The plug-in coupling as recited in claim 12 wherein the contact plate has a thickness of between 0.75 millimeters and 3 millimeters.

17: The plug-in coupling as recited in claim 12 wherein the contact limbs have a joining angle larger than a holding angle of the contact limbs.

18: The plug-in coupling as recited in claim 12 wherein each of the contact limbs has an elastic double tongue.

19: The plug-in coupling as recited in claim 18 wherein each of the double tongues is supported via two additional spring elements counteracting spreading apart of the two elastic double tongues, the two elastic double tongues being located opposite one another.

20: The plug-in coupling as recited in claim 12 wherein the contact regions are of linear design or extend both perpendicularly to the sliding-on direction and perpendicularly to the deflection direction.

21: The plug-in coupling as recited in claim 12 wherein the at least one contact plate includes two contact plates spaced apart from one another or further comprising a further contact plug spaced apart from the contact plug.

22: The plug-in coupling as recited in claim 12 wherein the contact plug is a stamping.

23: A hand-held power tool comprising the plug-in coupling as recited in claim 12 wherein the electrical contact plate of the plug-in coupling is connected to the hand-held power tool and the contact plug is arranged on a battery unit assigned to the hand-held power tool.
